(19) United States
(12) Patent Application Publication
(10) Pub. No.: US 2020/0402434 A1
(43) Pub. Date: Dec. 24, 2020

(54) Display Unit

(71) Applicant: Sony Corporation, Tokyo (JP)

(72) Inventors: Takashi Yamazuki, Tokyo (JP); Kazuhiro Hara, Tokyo (JP); Isamu Ikeda, Chiba (JP)

(73) Assignee: Sony Corporation, Tokyo (JP)

(21) Appl. No.: 16/767,346

(22) PCT Filed: Nov. 2, 2018
(86) PCT No.: PCT/JP2018/040892

§ 371 Date: May 27, 2020

(30) Foreign Application Priority Data
Dec. 6, 2017 (JP) 2017-234629

(51) Int. Cl. G09G 3/00; G06F 3/0487; G09F 9/35

(52) U.S. Cl. CPC G09G 3/035; G06F 3/0487; G09F 9/35; G09G 2380/02; G09G 2320/04; G09G 2320/0626; G09G 2354/00

(57) ABSTRACT

A display unit allowing a viewer to comfortably view an image is provided. This display unit includes: a winder including a rotary shaft; a flexible display that has a display surface where an image is displayed, and is windable and ejectable from the winder with rotation of the rotary shaft; a detector that detects a state of the display surface of the flexible display ejected from the winder; and a controller that performs switching control of a display mode of the image on the basis of the state of the display surface detected by the detector.

### TECHNICAL FIELD

The present disclosure relates to a display unit including a flexible display.

### BACKGROUND ART

A display unit including a flexible display panel with flexibility that is foldable or windable has been proposed before (for example, see PTL 1).

### CITATION LIST

### Patent Literature

PTL 1: Japanese Unexamined Patent Application Publication No. 2014-2348

### SUMMARY OF THE INVENTION

However, a display unit including such a flexible display is still desired to allow a viewer to comfortably view an image.

A display unit according to an embodiment of the present disclosure includes: a winder including a rotary shaft; a flexible display that has a display surface where an image is displayed, and is windable and drawable from the winder with rotation of the rotary shaft; a detector that detects a state of the display surface of the flexible display drawn from the winder; and a controller that performs switching control of a display mode of the image on the basis of the state of the display surface detected by the detector.

According to the display unit according to the embodiment of the present disclosure, a viewer is allowed to comfortably view an image.

It is to be noted that effects of the present disclosure are not necessarily limited to the effects described above, and may include any of effects that are described below.

### BRIEF DESCRIPTION OF DRAWING

FIG. 1 is a schematic front view of an entire configuration example of a display unit according to a first embodiment of the present disclosure.

FIG. 2A is a schematic front view of a first state of the display unit illustrated in FIG. 1, where a flexible display is stowed in a winder.

FIG. 2B is a schematic front view of a second state of the display unit illustrated in FIG. 1, where the flexible display is drawn halfway from the winder.

FIG. 3 is a block diagram illustrating a schematic configuration example of the display unit illustrated in FIG. 1.

FIG. 4 is a schematic front view of a first model case for describing control of a display mode in the display unit illustrated in FIG. 1.

FIG. 5 is a schematic front view of a second model case for describing control of a display mode in the display unit illustrated in FIG. 1.

FIG. 6 is a schematic front view of a third model case for describing control of a display mode in the display unit illustrated in FIG. 1.

FIG. 7 is a schematic front view of a fourth model case for describing control of a display mode in the display unit illustrated in FIG. 1.

FIG. 8 is a schematic perspective view of a fifth model case for describing control of a display mode in the display unit illustrated in FIG. 1.

FIG. 9 is a flowchart illustrating an example of an operation flow of image processing in the display unit illustrated in FIG. 1.

FIG. 10 is a schematic front view of an entire configuration example of a display unit as a modification example of the display unit illustrated in FIG. 1.

FIG. 11A is a schematic plan view of a first use example of the display unit illustrated in FIG. 10.

FIG. 11B is a schematic perspective view of the first use example of the display unit illustrated in FIG. 10.

FIG. 12A is a schematic plan view of a second use example of the display unit illustrated in FIG. 10.

FIG. 12B is a schematic perspective view of the second use example of the display unit illustrated in FIG. 10.

FIG. 13 is a schematic perspective view of an entire configuration example of a display unit according to a second embodiment of the present disclosure.

FIG. 14 is an explanatory diagram illustrating a case example of switching control of a display mode in the display unit illustrated in FIG. 13.

FIG. 15 is a schematic perspective view of an entire configuration example of a display unit as a first modification example of the display unit illustrated in FIG. 13.

FIG. 16 is a schematic perspective view of an entire configuration example of a display unit as a second modification example of the display unit illustrated in FIG. 13.

FIG. 17 is a schematic perspective view of an entire configuration example of a display unit as a third modification example of the display unit illustrated in FIG. 13.

FIG. 18A is a schematic perspective view of an entire configuration example of a display unit as a fourth modification example of the display unit illustrated in FIG. 13.

FIG. 18B is a schematic perspective view of an entire configuration example of a display unit as a fifth modification example of the display unit illustrated in FIG. 13.

### MODES FOR CARRYING OUT THE INVENTION

In the following, embodiments of the present disclosure are described in detail with reference to the drawings. It is to be noted that description is made in the following order.

### 1. First Embodiment

An example of a display unit that changes a display mode in accordance with, for example, flexure, deformation, inclination, or the like of a display surface of a flexible display

### 2. Second Embodiment

An example of a display unit that changes a display mode in accordance with an amount of ejection of a flexible display from a winder

### 3. Other Modification Example(s)

### 1. First Embodiment

### [Configuration of Display Unit 1]

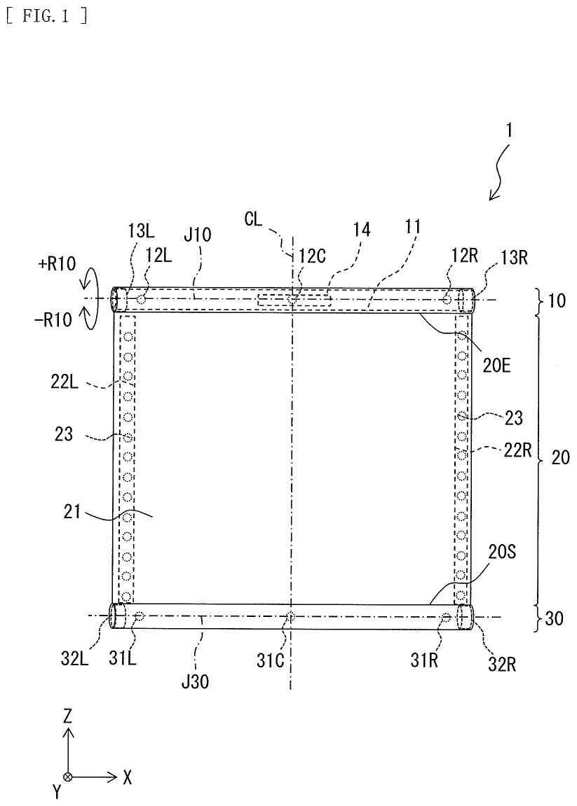

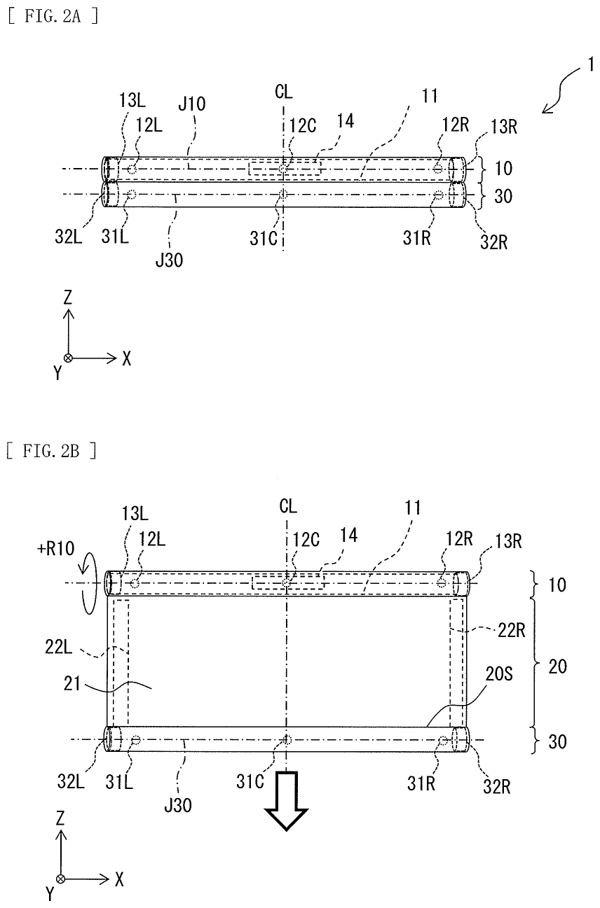

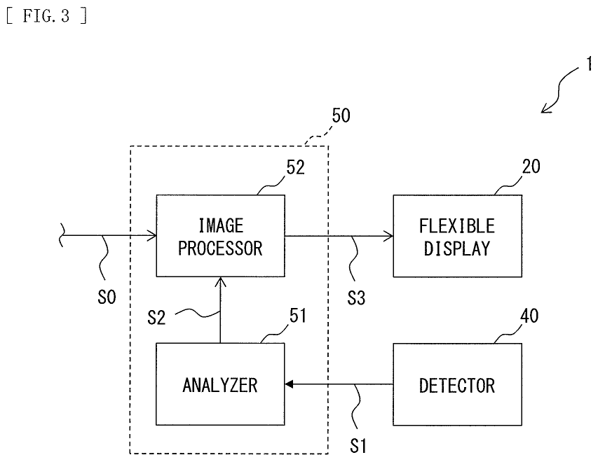

FIG. 1 schematically illustrates an entire configuration example of a display unit 1 according to a first embodiment of the present disclosure. FIG. 1 is a schematic front view of, in particular, an unwound state where a flexible display is fully drawn from a winder. FIG. 2A is a schematic front view of a stored state where the flexible display of the display unit 1 is stowed in the winder. FIG. 2B is a schematic front view of an intermediate state where the flexible display of the display unit 1 is drawn halfway from the winder. Moreover, FIG. 3 is a block diagram illustrating a schematic configuration example of the display unit 1.

As illustrated in FIG. 1, the display unit 1 includes a winder 10, a flexible display 20, and an unwinder 30. As illustrated in FIG. 3, the display unit 1 further includes a detector 40 and a controller 50.

### (Winder 10)

As illustrated in FIG. 1, etc., the winder 10 includes a shaft 11 that is rotatable bidirectionally in a +R10 direction and a −R10 direction around a rotary axis J10. The winder 10 is able to wind the flexible display 20, which is in a form of sheet with flexibility, around the shaft 11 with rotation of the shaft 11 in the −10R direction around the rotary axis J10, for example. The shaft 11 is a substantially cylindrical member including a material with a rigidity higher than that of the flexible display, examples of which include a metal material such as stainless steel and a hard resin. Nine-axis sensors 12L, 12C, and 12R, speakers 13L and 13R, a control board 14, etc. are disposed inside the shaft 11. Moreover, the winder 10 sequentially ejects the flexible display 20 with rotation of the shaft 11, a rotation center of which is the rotary axis J10, in the +R10 direction. It is to be noted that an axis parallel with the rotary axis J10 is defined as an X-axis in the present embodiment. Moreover, of axes orthogonal to the X-axis, an axis along a direction of ejection of the flexible display 20 is defined as a Z-axis. Further, an axis orthogonal to both the X-axis and Z-axis is defined as a Y-axis.

The nine-axis sensors 12L, 12C, and 12R, which are sensors that detect an attitude of the shaft 11, each include a gyroscope sensor, an acceleration sensor, and a geomagnetic sensor. The nine-axis sensor 12L is disposed in the shaft 11 near a left end portion as seen by a viewer, the nine-axis sensor 12R is disposed in the shaft 11 near a right end portion as seen by the viewer, and the nine-axis sensor 12C is disposed in the shaft 11 at a middle in a direction along the rotary axis J10. The gyroscope sensor is a sensor that detects an angular speed of the shaft 11. That is, the gyroscope sensor detects a rotation speed of the shaft 11 around each of the X-axis, Y-axis, and Z-axis. The acceleration sensor is a sensor that detects acceleration of movement of the shaft 11 along each of the X-axis, Y-axis, and Z-axis. The geomagnetic sensor is a three-axial electronic compass that detects geomagnetism a direction along each of the X-axis, Y-axis, and Z-axis. It is to be noted that the nine-axis sensors 12L, 12C, and 12R are each a component of the detector 40 (FIG. 3).

The speakers 13L and 13R are each an actuator that reproduces sound information. The speaker 13L is disposed in the shaft 11 near the left end portion as seen by the viewer and the speaker 13R is disposed in the shaft 11 near the right end portion as seen by the viewer.

For example, the control board 14 includes an operation receiver that receives an operation by the viewer, a power supply that receives externally supplied power, or an NFC communicator that performs external data communication, etc. The control board 14 preferably further includes a RAM (Random Access Memory), a ROM (Read Only Memory), a CPU (Central Processing Unit), etc., for example. The ROM is a rewritable non-volatile memory that stores a variety of information to be used by the display unit 1. The ROM stores a program to be executed by the display unit 1 and a variety of setting information based on various information detected by the detector 40. The CPU controls an operation of the display unit 1 by executing various programs stored in the ROM. The RAM functions as a temporal storage region in a case where this CPU executes a program.

### (Flexible Display 20)

The flexible display 20 is a display section in the form of sheet with flexibility, which is able to be stowed in the winder 10. The flexible display 20 has a display surface 21 where an image is displayed on the basis of an image signal supplied from a later-described image processor 52. The flexible display 20 includes, for example, a plurality of pixels using a self-emitting device, such as an organic EL (Electro Luminescence) device, or a display device, such as a liquid crystal device. A base end 20E of the flexible display 20 is coupled to the shaft 11 of the winder 10 and a distal end 20S of the flexible display 20 is coupled to an unwinder 30. The rotation of the shaft 11 in the −R10 direction around the rotary axis J10 allows the flexible display 20 to be wound on the winder 10 in sequence from the base end 20E toward the distal end 20S. In the stored state illustrated in FIG. 2A, the flexible display 20 is almost fully stowed in the winder 10 and thus the viewer is not able to see the flexible display 20. Meanwhile, the rotation of the shaft 11 in the +R10 direction around the rotary axis J10 allows the flexible display 20 to be ejected from the winder 10 in, for example, a −Z direction in sequence from the distal end 20S toward the base end 20E (see, for example, FIG. 2B). It is to be noted that a state where the display surface 21 of the flexible display 20 is aligned with both the X-axis and the Z-axis is referred to as a reference attitude of the flexible display 20.

For example, piezoelectric sensor units 22L and 22R, each of which includes a plurality of piezoelectric sensors 23 arranged along both X-axial edges, are disposed behind the display surface 21 of the flexible display 20. Each of the plurality of piezoelectric sensors 23 is a passive device including a piezoelectric body that converts applied force to voltage. Thus, in response to application of an external force, such as bending or twisting, to the display surface 21 of the flexible display 20, stress is applied to the plurality of piezoelectric sensors 23. The stress corresponds to a position of each of the piezoelectric sensors 23. It is to be noted that each of the plurality of piezoelectric sensors 23 is also a component of the detector 40 (FIG. 3).

### (Unwinder 30)

Similarly to, for example, the shaft 11, the unwinder 30 is a substantially cylindrical member including a material with a rigidity higher than that of the flexible display, examples of which include a metal material such as stainless steel and a hard resin. However, the unwinder 30 is not rotatable itself unlike the shaft 11, though being movable along the Z-axis away from the winder 10 or toward the winder 10. The distal end 20S of the flexible display 20 is coupled to the unwinder 30. Here, a center axis J30 along an extending direction of the substantially cylindrical unwinder 30 is desirably parallel with the rotary axis J10. It is to be noted that a state where the center axis J30 of the unwinder 30 is aligned with the X-axis is referred to as a reference attitude of the unwinder 30. The winder 10, the flexible display 20, and the unwinder 30 of the display unit 1 illustrated in FIG. 1 and FIG. 2A and FIG. 2B each correspond to the reference attitude.

This display unit 1 shifts to the intermediate state illustrated in FIG. 2B as a result of the unwinder 30 moving, starting from the stored state of FIG. 2A, in the −Z direction away from the winder 10. The display surface 21 of the flexible display 20 gradually appears with the shift from the stored state to the intermediate state, finally reaching the unwound state illustrated in FIG. 1. The unwound state of FIG. 1 is a state of the display unit 1 where the unwinder 30 is spaced farthest from the winder 10. Meanwhile, the display unit 1 shifts to the intermediate state illustrated in FIG. 2B as a result of the unwinder 30 moving, starting from the unwound state of FIG. 1, in a +Z direction toward the winder 10. The display surface 21 of the flexible display 20 is gradually hidden in the winder 10 with the shift from the unwound state to the intermediate state, finally reaching the stored state illustrated in FIG. 2A. The stored state of FIG. 2A is a state of the display unit 1 where the unwinder 30 and the winder 10 are closest to each other. It is to be noted that a state of the display unit 1 is able to be reversibly shifted in a range from the stored state to the unwound state. In addition, in a case of the above state shift of the display unit 1, that is, during the shift from the stored state (FIG. 2A) via the intermediate state (FIG. 2B) to the unwound state (FIG. 1) and during the shift from the unwound state (FIG. 1) via the intermediate state (FIG. 2B) to the stored state (FIG. 2A), it is desirable that a parallel state of the center axis J30 and the rotary axis J10 be maintained as much as possible. This allows a viewer to view a favorable image without the necessity of later-described image correction processing in addition to making it possible to apply less stress to the flexible display 20.

Nine-axis sensors 31L, 31C, and 31R, speakers 32L and 32R, etc. are disposed inside the unwinder 30.

The nine-axis sensors 31L, 31C, and 31R, which are sensors that detect an attitude of each of the unwinder 30 and the distal end 20S of the flexible display 20, each include a gyroscope sensor, an acceleration sensor, and a geomagnetic sensor. The nine-axis sensor 31L is disposed in the unwinder 30 near a left end portion as seen by the viewer, the nine-axis sensor 31R is disposed in the unwinder 30 near a right end portion as seen by the viewer, and the nine-axis sensor 31C is disposed in the unwinder 30 at the middle in the direction along the rotary axis J10. The nine-axis sensors 31L, 31C, and 31R are preferably substantially at positions oppose to the nine-axis sensors 12L, 12C, and 12R in a Z-axis direction, respectively. It is to be noted that the nine-axis sensors 31L, 31C, and 31R are also each a component of detector 40 (FIG. 3).

### (Detector 40)

The detector 40 includes the nine-axis sensors 12L, 12C, and 12R disposed in the winder 10, the plurality of piezoelectric sensors 23 disposed in the flexible display 20, and the nine-axis sensors 31L, 31C, and 31R disposed in the unwinder 30 as described above. The detector 40 functions to acquire a variety of information regarding the display unit 1 with the above variety of sensors and send the variety of information as a detection signal S1 to an analyzer 51 (described later) of the controller 50 as illustrated in FIG. 3, for example. Specifically, the detector 40 acquires, as the variety of information, attitude information regarding the winder 10 with the nine-axis sensors 12L, 12C, and 12R and sends the attitude information as the detection signal S1 to the analyzer 51. Alternatively, the detector 40 acquires information regarding deformation of the display surface 21 with the plurality of piezoelectric sensors 23 and sends the information as the detection signal S1 to the analyzer 51. The detector 40 further acquires attitude information regarding the unwinder 30 with the nine-axis sensors 31L, 31C, and 31R and sends the information as the detection signal S1 to the analyzer 51.

### (Controller 50)

The controller 50 includes the analyzer 51 and the image processor 52 as, for example, functions of the CPU provided on the control board 14 as illustrated in FIG. 3.

The analyzer 51 analyzes the variety of information sent from the detector 40 and estimates, as a result of the analysis, a state of the display unit 1, especially, a state of the display surface 21. For example, the analyzer 51 analyzes changes in respective voltages detected by the piezoelectric sensor units 22L and 22R, thereby making it possible to estimate which portion of the display surface 21 of the flexible display 20 has bend or deformation and an amount of the bend or deformation. Moreover, the analyzer 51 collectively analyzes the attitude information regarding the winder 10 provided by the nine-axis sensors 12L, 12C, and 12R and the attitude information regarding the unwinder 30 provided by the nine-axis sensors 31L, 31C, and 31R, thereby making it possible to estimate a shape of the display surface 21.

The analyzer 51 sends the result of the analysis as an analysis signal S2 to the image processor 52. The image processor 52 performs switching control of a display mode of an image displayed on the display surface 21 by, for example, correcting an externally inputted image signal on the basis of the result of the analysis of the analyzer 51. The image processor 52 sends an image signal S3 having been subjected to the image processing to the flexible display 20 (FIG. 3).

### [Operation of Display Unit 1]

### (A. Basic Operation)

First, description will be made on a basic operation of the display unit 1. When the display unit 1 is turned off, this display unit 1 is in the stored state illustrated in FIG. 2A. That is, the flexible display 20 is stored in the winder 10, and the winder 10 and the unwinder 30 are closest to each other. When the display unit 1 is turned on by operating a remote controller or the like, the display unit 1 shifts from the stored state of FIG. 2A via the intermediate state of FIG. 2B to the unwound state of FIG. 1. The display unit 1 may be turned on in response to voice instructions or an image signal S0 externally inputted to the image processor 52. In addition, this display unit 1 acquires information regarding an attitude of the winder 10 (shaft 11) relative to the reference attitude with the nine-axis sensors 12L, 12C, and 12R in accordance with, for example, instructions of the controller 50 at all times, and stores the information in the ROM or the like of the control board 14. Likewise, the display unit 1 acquires information regarding an attitude of the distal end 20S and the unwinder 30 relative to the reference attitude with the nine-axis sensors 31L, 31C, and 31R in accordance with the instructions of the controller 50 at all times, and stores the information in the ROM or the like of the control board 14. Further, the display unit 1 acquires information regarding bend or deformation of the display surface 21 of the flexible display 20 with the plurality of piezoelectric sensors 23 in accordance with the instructions of the controller 50 at all times, and stores the information in the ROM or the like of the control board 14.

In this display unit 1, as illustrated in FIG. 3, the image processor 52 performs the image processing on the externally inputted image signal S0 and the image signal S3 generated by the image processor 52 is inputted to the flexible display 20. The image processing includes switching control of a display mode of an image to be performed on the basis of the analysis signal S2 from the analyzer 51. The analyzer 51 performs analysis on the basis of the variety of information contained in the detection signal S1 from the detector 40. The flexible display 20 displays an image in a display mode based on the image signal S3 from the image processor 52.

### (B. Detailed Operation)

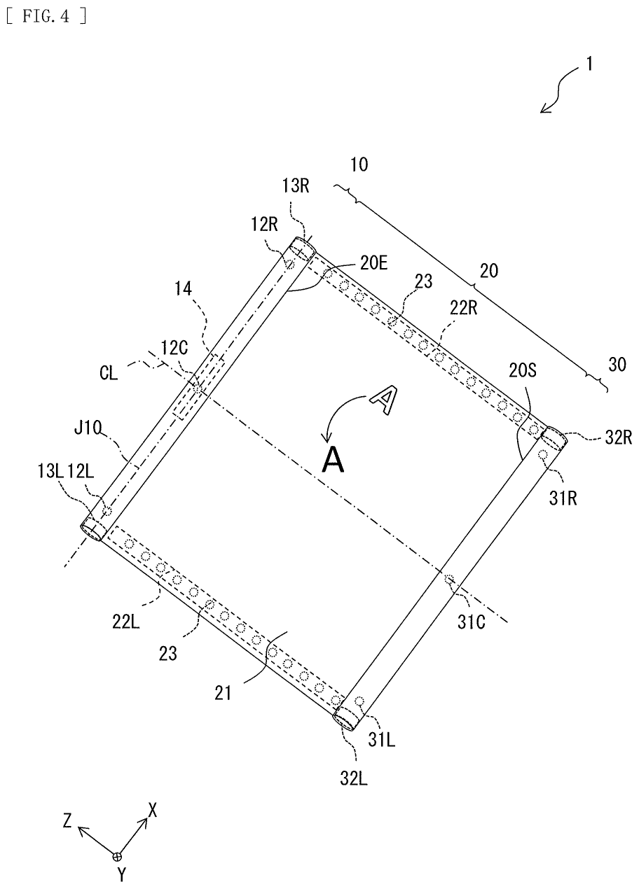

Next, referring to FIG. 4 to FIG. 8 in addition to FIG. 1 to FIG. 3, description will be made on detailed operations of the display unit 1 in several cases.

### (B-1. Case 1)

A case 1 is switching control of a display mode to be performed if the entire display unit 1 is inclined relative to a reference direction (for example, vertical direction). Here, the inclination relative to the reference direction (for example, vertical direction) refers to an inclination relative to a vertical direction of a centerline CL along a direction of ejection and storing of the flexible display 20 (Z-axis direction) as illustrated in FIG. 4, for example. FIG. 4 is a schematic front view of a first model case (case 1) for describing control of a display mode in the display unit 1. FIG. 4, in which an up-down direction of a paper surface corresponds to the vertical direction, illustrates that the centerline CL of the display unit 1 is inclined relative to the vertical direction. In this case, the detector 40 detects the inclination of the centerline CL of the flexible display 20, which is ejected from the winder 10, relative to the vertical direction with the nine-axis sensors 12L, 12C, 12R, 31L, 31C, and 31R. It is to be noted that all or some of the nine-axis sensors 12L, 12C, 12R, 31L, 31C, and 31R may be used to detect the inclination of the centerline CL relative to the vertical direction.

In a typical display unit, an image is displayed in a direction along any one of outer edges of a rectangular screen being defined as the up-down direction. For example, as illustrated as an example in FIG. 4, an outlined alphabet A is displayed in the X-axis direction being defined as the up-down direction, for example. However, the X-axis direction is inclined relative to the vertical direction, which makes this image illegible for a viewer who views it. Accordingly, the display unit 1 according to the present disclosure causes the controller 50 to perform, as the switching control of a display mode, correction of the inclination of the image in accordance with the inclination, detected by the detector 40, of the centerline CL of the display surface 21 relative to the vertical direction. That is, the analyzer 51 obtains an inclination angle of the centerline CL relative to the vertical direction and the image processor 52 performs image processing to turn the image, bringing the up-down direction of the image, i.e., an up-down direction of a bold alphabet A in the example of FIG. 4, into alignment with the vertical direction. This provides an image easy for the viewer to see.

### (B-2. Case 2)

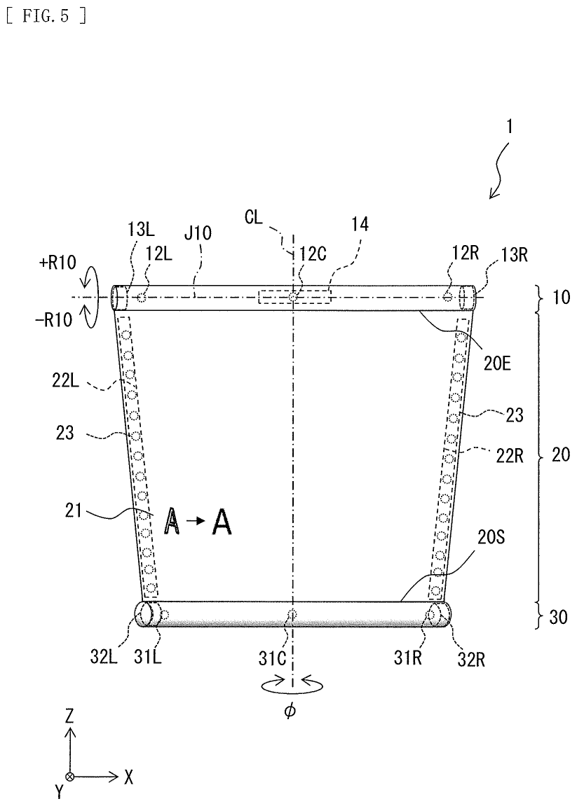

A case 2 is switching control of a display mode to be performed if the center axis J30 of the unwinder 30 is twisted relative to the rotary axis J10 of the winder 10. This twist refers to a state where the center axis J30 of the unwinder 30 is rotated around the centerline CL, which is along the Z-axis, within an XY plane as illustrated in FIG. 5, for example. FIG. 5 is a schematic front view of a second model case (case 2) for describing the control of a display mode in the display unit 1. In this case, assuming that the reference attitude where the rotary axis J10 and the center axis J30 are both in the X-axis direction corresponds to a rotation angle ϕ=0°, the rotation angle ϕ increases with separation of the center axis J30 from the X-axis toward the Y-axis. The rotation angle ϕ is obtained by the analyzer 51 from a relationship between the attitude of the winder 10 detected by the nine-axis sensors 12L, 12C, and 12R and the attitudes of the unwinder 30 and the distal end 20S detected by the nine-axis sensors 31L, 31C, and 31R.

Deformation of the display surface 21 increases with an increase in the rotation angle ϕ. As a result, in a typical display unit, an image displayed on the display surface 21 is also deformed. For example, an image shrunk in a left-right direction (X-axis direction) and deformed as a whole, such as an outlined alphabet A illustrated as an example in FIG. 5, is displayed. The image is thus illegible for a viewer as it stands. Accordingly, the display unit 1 according to the present disclosure causes the controller 50 to perform, as the switching control of a display mode, correction of the deformation of the image in accordance with the twist of the display surface 21 detected by the detector 40. That is, the image processor 52 performs image processing to make the image undeformed for a viewer who looks at the display surface 21 along the +Y direction. This provides an image easy for the viewer to see.

In this display unit 1, it is to be noted that the rotary axis J10 and the center axis J30 may be automatically fine-adjusted to be brought closer to being parallel with each other by the control of the controller 50 on the basis of the detection signal S1 from the detector 40. In this case, the display unit 1 preferably further includes an adjustment mechanism including a support body for adjusting the attitudes of the winder 10 and the unwinder 30. Alternatively, an instruction image may be displayed on the display surface 21 to bring the rotary axis J10 and the center axis J30 closer to being parallel with each other by the control of the controller 50, allowing a viewer to manually fine-adjust the rotary axis J10 and the center axis J30 by him- or herself.

### (B-3. Case 3)

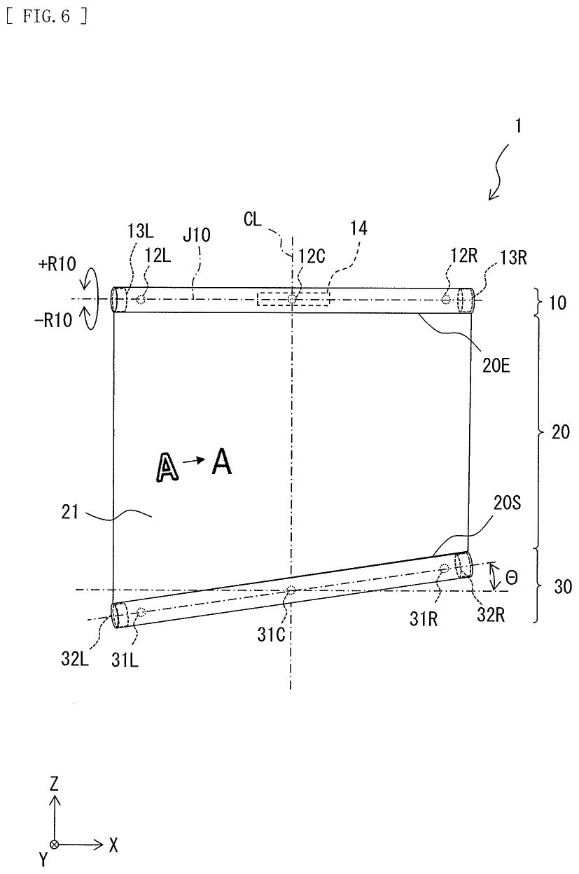

A case 3 is switching control of a display mode to be performed if the center axis J30 of the unwinder 30 is inclined relative to the rotary axis J10 of the winder 10. This inclination refers to a state where the center axis J30 of the unwinder 30 is rotated around the Y-axis, which is orthogonal to the Z-axis and the X-axis, or vertical to the display surface 21 in the reference attitude, within an XZ plane as illustrated in FIG. 6, for example. FIG. 6 is a schematic front view of a third model case (case 3) for describing the control of a display mode in the display unit 1. In this case, assuming that the reference attitude where the rotary axis J10 and the center axis J30 are both in the X-axis direction corresponds to a rotation angle Θ=0°, the rotation angle Θ increases with separation of the center axis J30 from the X-axis toward the Z-axis. The rotation angle Θ is obtained by the analyzer 51 from the relationship between the attitude of the winder 10 detected by the nine-axis sensors 12L, 12C, and 12R and the attitudes of the unwinder 30 and the distal end 20S detected by the nine-axis sensors 31L, 31C, and 31R.

Flexure of the display surface 21 increases with an increase in the rotation angle Θ. As a result, in a typical display unit, an image displayed on the display surface 21 is also inclined or deformed. For example, an image deformed as a whole while an up-down direction thereof is inclined relative to the vertical direction, such as an outlined alphabet A illustrated as an example in FIG. 6, is displayed. The image is thus illegible for a viewer as it stands. Accordingly, the display unit 1 according to the present disclosure causes the controller 50 to perform, as the switching control of a display mode, correction of the deformation and inclination of the image in accordance with the flexure of the display surface 21 detected by the detector 40. That is, the image processor 52 performs image processing to make the image undeformed for a viewer who looks at the display surface 21 along the +Y direction. This provides an image easy for the viewer to see.

In the case 3, it is to be noted that the rotary axis J10 and the center axis J30 may be automatically fine-adjusted to be brought closer to being parallel with each other by the control of the controller 50 on the basis of the detection signal S1 from the detector 40 as in the case 2. In this case, the display unit 1 preferably further includes an adjustment mechanism including a support body for adjusting the attitudes of the winder 10 and the unwinder 30. Alternatively, an instruction image may be displayed on the display surface 21 to bring the rotary axis J10 and the center axis J30 closer to being parallel with each other by the control of the controller 50, allowing a viewer to manually fine-adjust the rotary axis J10 and the center axis J30 by him- or herself.

### (B-4. Case 4)

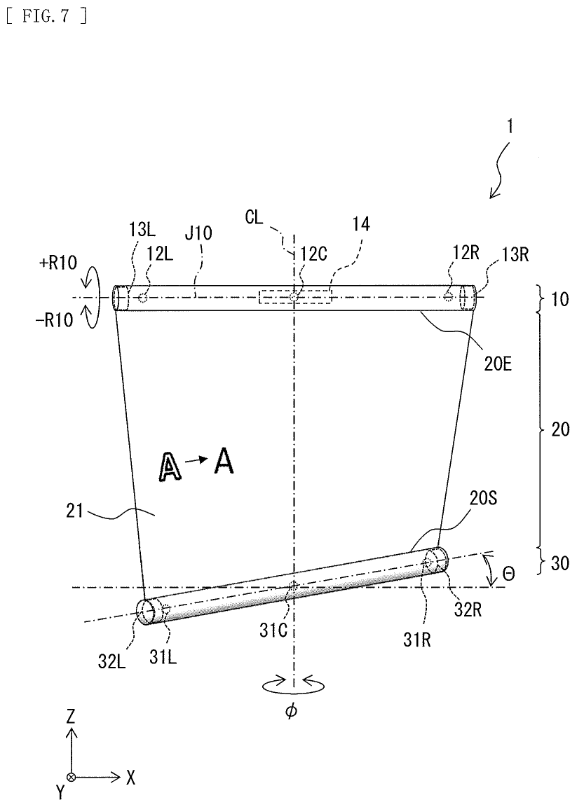

A case 4 is switching control of a display mode to be performed if the center axis J30 of the unwinder 30 is twisted and inclined relative to the rotary axis J10 of the winder 10. An example as illustrated in FIG. 7 is a state where the twist of the case 2 (FIG. 5) and the inclination of the case 3 (FIG. 6) occur in combination. FIG. 7 is a schematic front view of a fourth model case (case 4) for describing the control of a display mode in the display unit 1. In this case, the controller 50 performs, as the switching control of a display mode, correction of deformation of an image in accordance with the twist and flexure of the display surface 21 detected by the detector 40. That is, the image processor 52 performs image processing to make the image undeformed for a viewer who looks at the display surface 21 along the +Y direction. This provides an image easy for the viewer to see.

### (B-5. Case 5)

A case 5 is switching control of a display mode to be performed if the flexible display 20 is folded at any position. In the switching control of a display mode of this case, an image region is divided if the flexible display 20 is folded along, for example, a folding line BP that is along the extending direction of the winder 10 and the unwinder 30 as illustrated in FIG. 8, for example. That is, the region in the display surface 21 is divided into two regions that are a first region 21A between the folding line BP and the winder 10 and a second region 21B between the folding line BP and the unwinder 30, and an image is displayed in each region. This makes it possible for a viewer V1 and a viewer V2 standing at a position opposite to that of the viewer V1 to simultaneously view an image on the display unit 1, for example. It is to be noted that FIG. 8 illustrates a state where the viewer V1 views image light L1 of a bold alphabet A displayed in the first region 21A while the viewer V2 views image light L2 of an outlined alphabet A displayed in the second region 21B. FIG. 8 is a schematic perspective view of a fifth model case (case 5) for describing the control of a display mode in the display unit 1. It is to be noted that FIG. 8 illustrates none of the plurality of piezoelectric sensors 23.

In this case, the plurality of piezoelectric sensors 23 provided in each of the piezoelectric sensor units 22L and 22R of the detector 40 detects folding positions BL and BR in the flexible display 20 and the analyzer 51 specifies the folding line BP. The image processor 52 performs correction to cause the image to be displayable in each region in accordance with the folding line BP, that is, in accordance with sizes and shapes of the first region 21A and the second region 21B. In this regard, the deformation and the inclination are corrected, allowing an image displayed in the first region 21A to be an image easy for the viewer V1 to view. Simultaneously, the deformation and the inclination are corrected, allowing an image displayed in the second region 21B to be an image easy for the viewer V2 to view. It is to be noted that the image displayed in the first region 21A and the image displayed in the second region 21B may be the same as or different from each other if necessary.

As described above, in the case 5, the screen is divided in accordance with the folding positions in the flexible display 20 and images are corrected to be easy for viewers facing the respective divided screen regions to see. This provides an excellent user-friendliness in addition to providing the images easy for the viewers to see.

### (C. Operation Flow)

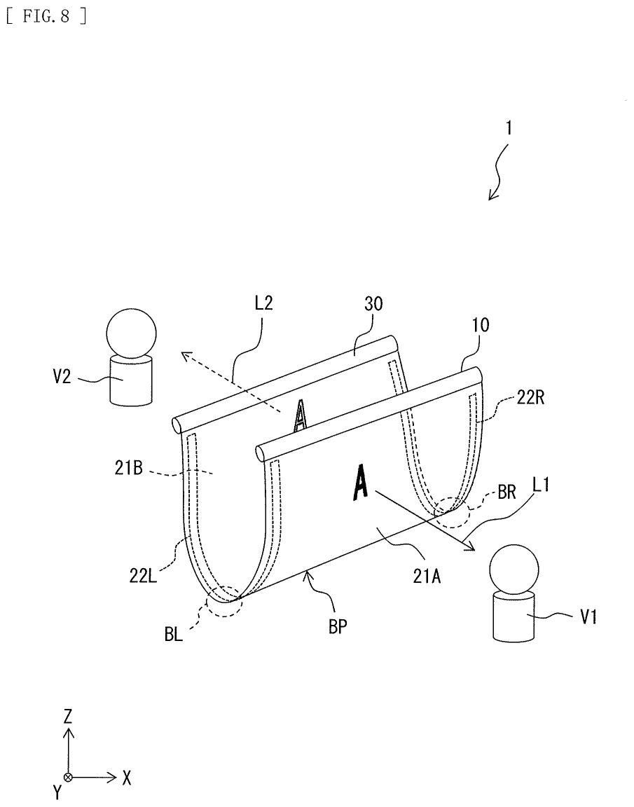

The above operation flows of the display unit 1 will be collectively described with reference to a flowchart of FIG. 9. FIG. 9 is a flowchart illustrating an example of an operation flow of the display unit 1 including the image processing.

First, an unwinding operation of the flexible display 20 is started by an operation such as turning on the control board 14 of the display unit 1 in response to a remote control operation by a viewer (step S101). It is to be noted that the unwinding operation of the flexible display 20 may be started by, for example, pulling the unwinder 30 in an ejection direction of the flexible display 20 (in an example of FIG. 1, −Z direction) in addition to turning on the display unit 1.

The controller 50 acquires, responsive to the display unit 1 being turned on, the image signal S0 from an external unit and saves it in the ROM or the like of the control board 14 (step S102). Further, the controller 50 acquires, responsive to the display unit 1 being turned on, the detection signal S1 from the detector 40 and saves it in the ROM or the like of the control board 14 (step S103).

The controller 50 causes the analyzer 51 to analyze the detection signal S1 and determines whether or not inclination of the centerline CL of the flexible display 20 relative to the vertical direction occurs (step S104). If the inclination of the centerline CL of the flexible display 20 relative to the vertical direction is detected (S104Y), the controller 50 causes the analyzer 51 to analyze the detection signal S1, obtains an inclination angle, and causes the image processor 52 to perform the image processing to correct an inclination of the image (step S105). In this regard, the analysis signal S2 including information regarding the inclination angle is saved in the ROM or the like of the control board 14. The process then returns to step S104.

If no inclination of the centerline CL of the flexible display 20 relative to the vertical direction is detected in step S104 (S104N), the process proceeds to step S106. In step S106, the controller 50 causes the analyzer 51 to analyze the detection signal S1 and determines whether or not twist of the center axis J30 of the unwinder 30 occurs.

If the twist of the center axis J30 of the unwinder 30 is detected in step S106 (S106Y), the controller 50 causes the analyzer 51 to analyze the detection signal S1 and obtains the rotation angle ϕ of the twist. Further, the image processor 52 performs the image processing to correct the twist on the basis of the analysis signal S2 including information regarding the rotation angle ϕ (step S107). In this regard, the analysis signal S2 including the information regarding the rotation angle ϕ is saved in the ROM or the like of the control board 14. The process then returns to step S106.

If no twist of the center axis J30 of the unwinder 30 is detected in step S106 (S106N), the process proceeds to step S108. In step S108, the controller 50 causes the analyzer 51 to analyze the detection signal S1 and determines whether or not flexure of the display surface 21, that is, rotation of the unwinder 30 around the Y-axis, occurs.

If the flexure of the display surface 21 is detected in step S108 (S108Y), the controller 50 causes the analyzer 51 to analyze the detection signal S1, obtaining the rotation angle Θ. Further, the image processor 52 performs the image processing to correct the flexure of the display surface 21 on the basis of the analysis signal S2 including information regarding the rotation angle Θ (step S109). In this regard, the analysis signal S2 including the information regarding the rotation angle Θ is saved in the ROM or the like of the control board 14. The process then returns to step S108.

If no flexure of the display surface 21 is detected in step S108 (S108N), the process proceeds to step S110. In step S110, it is determined whether or not the flexible display 20 is folded.

If it is detected that the flexible display 20 is folded in step S110 (S110Y), the controller 50 causes the analyzer 51 to analyze the detection signal S1, specifying the folding line BP. Further, the image processor 52 divides the screen on the basis of the analysis signal S2 including information regarding the specified folding line BP. The image processor 52 performs the image processing to correct the image to be displayable in each region in accordance with the sizes and shapes of the first region 21A and the second region 21B (step S111). In this regard, the analysis signal S2 including the information regarding the specified folding line BP is saved in the ROM or the like of the control board 14. The process then returns to step S110.

Then, the image signal S3 is sent to the flexible display 20, and the image signal S3 is saved in the ROM or the like of the control board 14 (step S112).

Next, it is detected whether or not a save operation of a variety of settings has been performed by the viewer (step S113). If it is not detected that the save operation of the variety of settings has been performed by the viewer (S113N), the operation of the display unit 1 is terminated by turning the power off or by performing a storing operation for the flexible display 20 and then turning the power off (END). If it is detected that the save operation of the variety of settings has been performed by the viewer (S113Y), the variety of information is saved in the ROM or the like of the control board 14 (step S114). The saved variety of information relates to a form that reflects preference of the viewer and thus is applicable to next and subsequent variety of settings or image processing operations.

### [Workings and Effects of Display Unit 1]

As described above, in the display unit 1 according to the present embodiment, a state of the display surface 21 of the flexible display 20 ejected from the winder 10 is detected and a display mode of an image is switched on the basis of the state, which provides an easy-to-see and comfortable viewing environment for a viewer.

For example, it is possible for the detector 40 to detect an inclination of the flexible display 20 ejected from the winder 10 relative to the vertical direction, and it is possible for the controller 50 to correct, in accordance with the inclination, an inclination of an image as the switching control of a display mode. Therefore, even if at least one of a face of a viewer or the display surface 21 is inclined, an easy-to-see and comfortable viewing environment for the viewer is provided.

Moreover, for example, it is possible for the detector 40 to detect an attitude of the distal end 20S of the flexible display 20 opposite to the winder, and it is possible for the controller 50 to correct deformation of an image in accordance with the attitude. Therefore, even if twist or flexure of the display surface 21 of the flexible display 20 ejected from the winder 10 occurs, an easy-to-see and comfortable viewing environment for a viewer is provided.

Moreover, for example, it is possible for the detector 40 to detect the folding positions BL and BR in the flexible display 20, and it is possible for the controller 50 to divisionally displays an image in accordance with the folding positions BL and BR. This enables a more flexible image display, such as bidirectional viewing, providing an easy-to-see and comfortable viewing environment for a viewer.

### Modification Example of First Embodiment

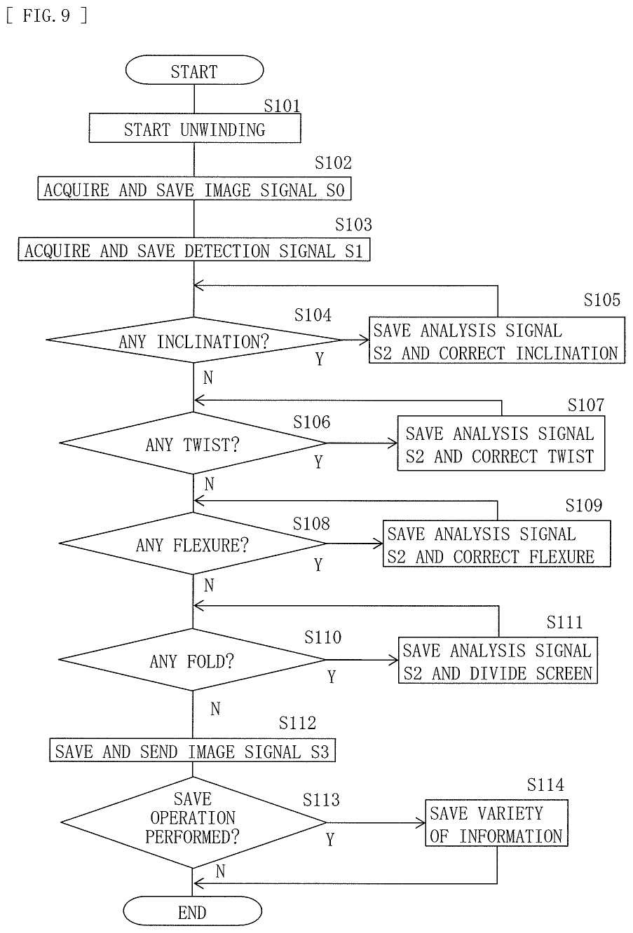

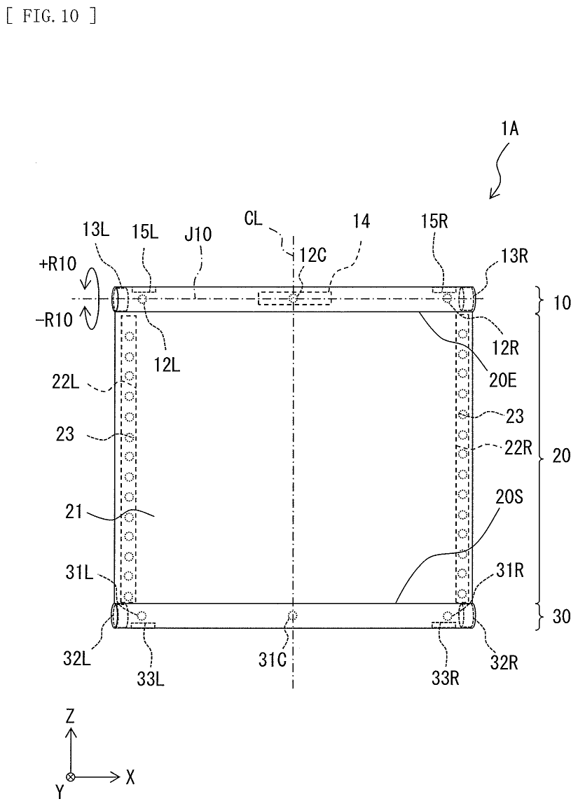

Next, referring to FIG. 10, description will be made on a display unit 1A as a modification example of the first embodiment. FIG. 10 is a schematic front view of an entire configuration example of the display unit 1A. In the display unit 1A, the winder 10 further includes proximity sensors 15L and 15R, and the unwinder 30 further includes proximity sensors 33L and 33R. The other configuration other than this is substantially the same as that of the display unit 1 of the above-described first embodiment.

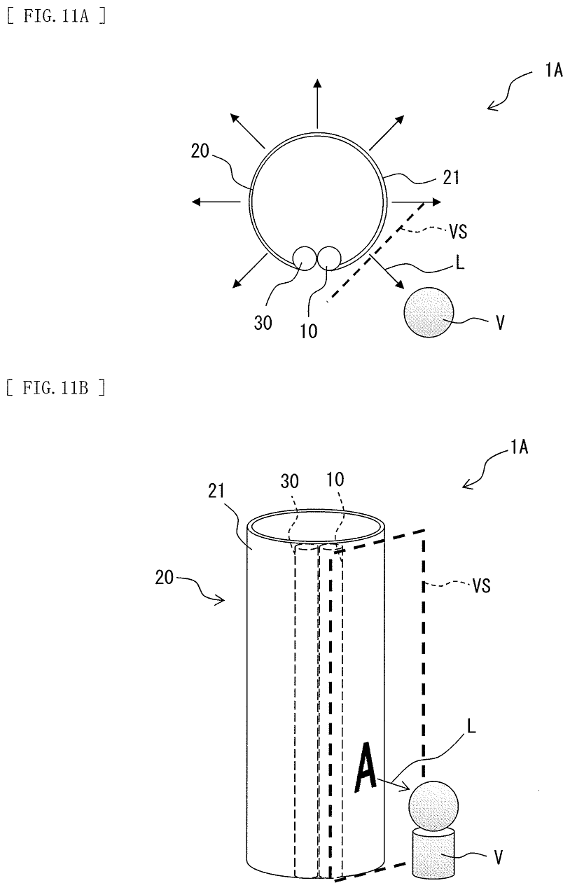

The proximity sensors 15L and 15R are disposed in the shaft 11 of the winder 10 near an upper end thereof. Meanwhile, the proximity sensors 33L and 33R are disposed in the unwinder 30 near a lower end thereof. The proximity sensors 15L and 15R and the proximity sensors 33L and 33R are each also a component of the detector 40. As illustrated in FIG. 11A and FIG. 11B, in the display unit 1A, the flexible display 20 is cylindrically curved, thereby bringing the proximity sensor 15L and the proximity sensor 33L closer to each other and bringing the proximity sensor 15R and the proximity sensor 33R closer to each other. It is to be noted that FIG. 11A is a schematic plan view of a first use example of the display unit 1A and FIG. 11B is a perspective view corresponding thereto.

In a mode of FIG. 11A and FIG. 11B, the display surface 21 of the cylindrically curved flexible display 20 faces outside with the winder 10 and the unwinder 30 placed in a space surrounded by the flexible display 20. It is to be noted that the display unit 1A is desirably installed with the X-axis directed in the vertical direction. In this case, a viewer is able to view the display surface 21 from all directions around the display unit 1A.

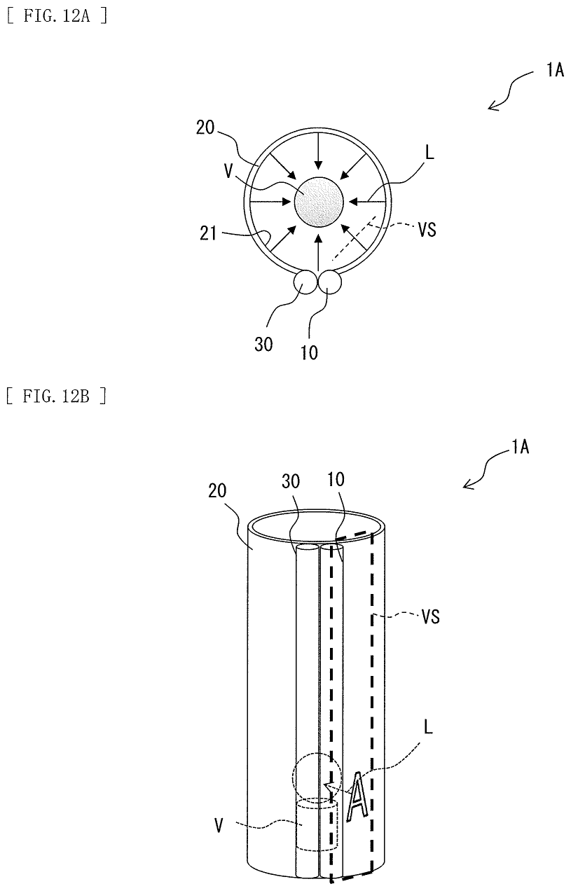

Further, as illustrated in FIG. 12A and FIG. 12B, this display unit 1A allows the display surface 21 of the cylindrically curved flexible display 20 to face inside so that a viewer V is placed in a space surrounded by the flexible display 20. It is to be noted that FIG. 12A is a schematic plan view of a second use example of the display unit 1A and FIG. 12B is a perspective view corresponding thereto. In this case, the winder 10 and the unwinder 30 are disposed outside the space surrounded by the flexible display 20. In this case, it is to be noted that the display unit 1A is also desirably installed with the X-axis directed in the vertical direction. In a case of this second use example, a viewer is able to receive image light from the display surface 21 of the display unit 1A from all directions.

However, in either the first use example or the second use example of the display unit 1A, the viewer V faces the display surface 21 curved in the left-right direction while being flat in the up-down direction. Accordingly, in the display unit 1A, the analyzer 51 calculates a curvature of the display surface 21 on the basis of the detection signal S1 from the piezoelectric sensor units 22L and 22R of the detector 40 to estimate the shape of the display surface 21. The image processor 52 provides, on the basis of a result of the analysis, the image signal S3 for creating an image corrected to form a virtual screen VS that faces the viewer V to the flexible display 20. As a result, an image light L easy for the viewer V to see is provided to the viewer V, though the display surface 21 itself is curved.

Further, in the display unit 1A, in a case where the detector 40 detects that the winder 10 and the unwinder 30, which is disposed at the distal end 20S opposite to the winder 10, come into contact with or come closer to each other, the controller 50 performs switching to a circumferential image display mode. Specifically, in response to detecting that the flexible display 20 is cylindrically curved bringing the proximity sensor 15L and the proximity sensor 33L closer to each other and the proximity sensor 15R and the proximity sensor 33R closer to each other, such detection is sent as the detection signal S1 to the analyzer 51. The analyzer 51 estimates that the flexible display 20 should be cylindrically curved and sends such estimation as the analysis signal S2 to the image processor 52. The image processor 52 performs, on the basis of the analysis signal S2 from the analyzer 51, the switching to the circumferential image display mode, where a circumferential image, that is, an image uninterrupted and continuous all around 360 degrees, is displayed.

As described above, in the display unit 1A, in response to both edges of the flexible display 20 coming into contact with or closer to each other, normal image display is switched to circumferential image display. This provides a comfortable viewing environment for a viewer, such as being able to see a circumferentially uninterrupted circumferential image with a realistic sensation.

### 2. Second Embodiment

### [Configuration of Display Unit 2]

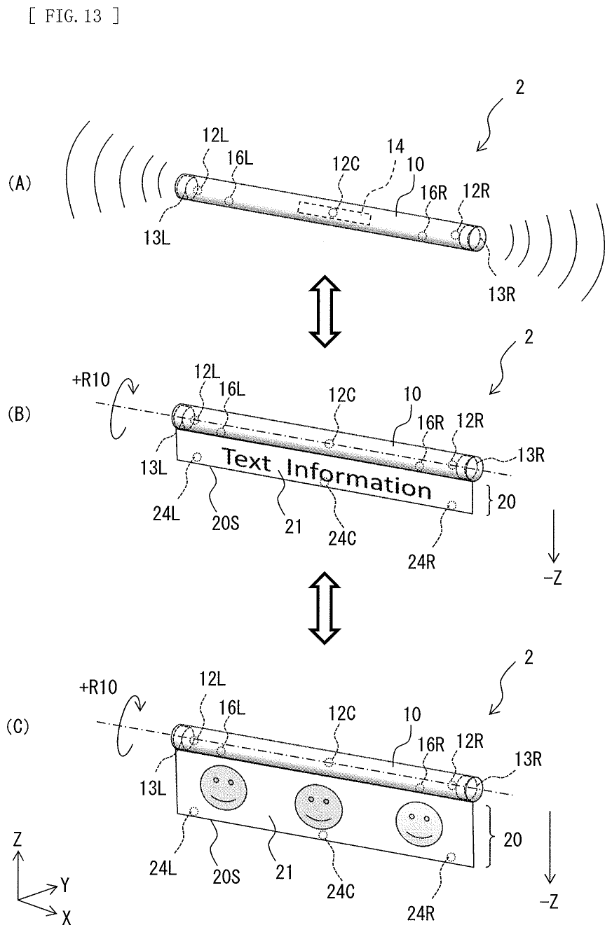

FIG. 13 schematically illustrates an entire configuration example of a display unit 2 according to a second embodiment of the present disclosure. In FIG. 13, in particular, (A) illustrates a first state (stored state) where the flexible display 20 is stored in the winder 10. (B) of FIG. 13 illustrates a second state where a portion of the flexible display 20 is slightly ejected from the winder 10. (C) of FIG. 13 illustrates a third state where a larger portion of the flexible display 20 is ejected from the winder 10. The display unit 2 may be in a fourth state, that is, an unwound state, where the entirety of the flexible display 20 is ejected in addition to the first state, the second state, and the third state. A state of the display unit 2 is able to be reversibly shifted in a range from the first to fourth states.

The display unit 2 has substantially the same configuration as that of the display unit 1 except for not including the unwinder 30. It is to be noted that the display unit 2 further includes, as a component of the detector 40, displacement sensors 16L and 16R that detect an amount of ejection of the flexible display 20, that is, a length of the flexible display 20 ejected in the −Z direction. Moreover, the display unit 2 further includes nine-axis sensors 24L, 24C, and 24R disposed near the distal end 20S of the flexible display 20 in place of the nine-axis sensors 31L, 31C, and 31R disposed in the unwinder 30 of the display unit 1. The display unit 2 is thus able to perform switching control of a display mode of an image similar to that of the display unit 1 according to the above-described first embodiment.

In the display unit 2, the displacement sensors 16L and 16R of the detector 40 detect an amount of ejection of the flexible display 20 from the winder 10 and the controller 50 performs the switching control of a display mode of an image in accordance with the amount of ejection. For the switching control of a display mode of an image, the controller 50 functions to select any one of an unlighted mode, a text display mode, a thumbnail display mode, or a full-screen display mode to display an image on the display surface 21. That is, the controller 50 changes an amount of information regarding the image to be displayed on the display surface 21 in accordance with the amount of ejection of the flexible display 20 from the winder 10.

For example, in the first state (stored state) illustrated in (A) of FIG. 13, only sound information is outputted without displaying any image. In the second state illustrated in (B) of FIG. 13, text information is displayed with the sound information without displaying any image, or solely compactly displayed. In the third state illustrated in (C) of FIG. 13, for example, thumbnail display as image display is provided with the sound information, or solely provided. The text information may be compactly displayed with the thumbnail display. Further, in the fourth state, that is, the unwound state where the entirety of the flexible display 20 is ejected, full-screen display is possible on the display surface 21.

As described above, in the display unit 2, the switching control of a display mode of an image is performed in accordance with an amount of ejection of the flexible display 20 from the winder 10. Accordingly, by adjusting an amount of ejection of the flexible display 20 from the winder 10 in accordance with intention of a viewer, it is possible for the viewer to acquire necessary information desired by him- or herself in a preferred mode. For example, in a case where it is desired to check news, weather forecast, RSS feed, or the like, the full-screen display is not necessary. Accordingly, the display mode illustrated in FIG. 13(A) in which only sound information is provided and the display surface 21 is unlighted, or the display mode illustrated in FIG. 13(B) in which only text information is provided is preferably selected, for example. By doing so, the display unit 2 provides a viewing environment according to preference of a viewer.

Moreover, in the display unit 2, the controller 50 may further perform switching control of an acoustic mode of sound in accordance with an amount of ejection of the winder 10 from the flexible display 20 detected by the displacement sensors 16L and 16R. By providing, in conjunction with a display mode of an image, an acoustic mode where a frequency band suitable for a viewer to hear voice of people or providing an acoustic mode with a further realistic sensation, for example, a comfortable viewing environment according to preference of the viewer is provided.

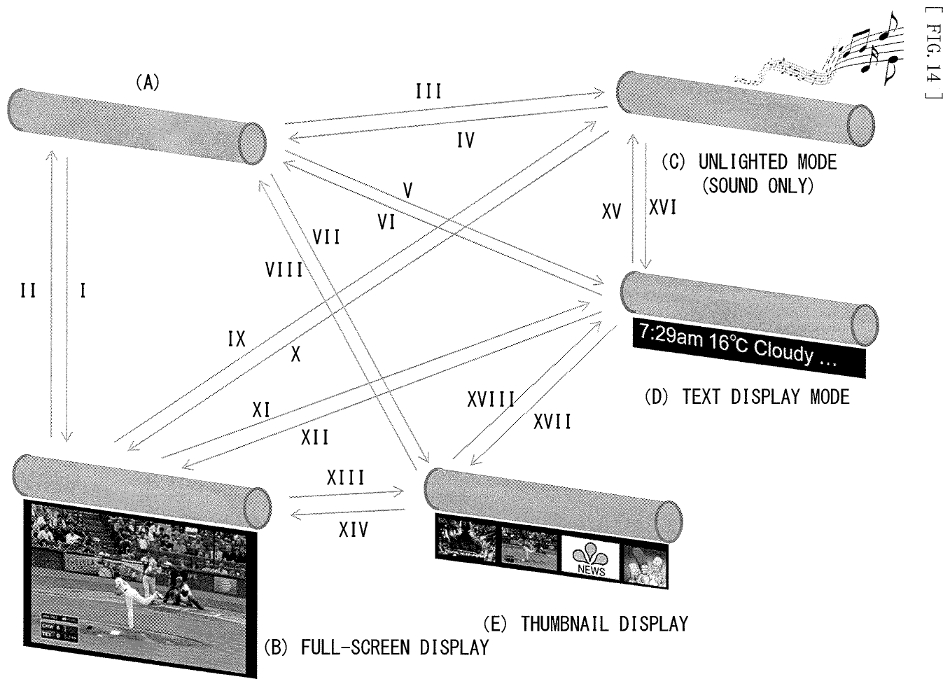

It is to be noted that direct switching is preferably possible between a plurality of display modes in the display unit 2 as in a case of the switching control of a display mode illustrated in FIG. 14, for example. (A) of FIG. 14 illustrates a power off state, (B) of FIG. 14 illustrates the full-screen display mode, (C) of FIG. 14 illustrates the unlighted mode, (D) of FIG. 14 illustrates the text display mode, and (E) of FIG. 14 illustrates the thumbnail display mode. That is, any one of routes I to XVIII illustrated in FIG. 14 may be taken as a route for performing the switching control of a display mode.

### First Modification Example of Second Embodiment

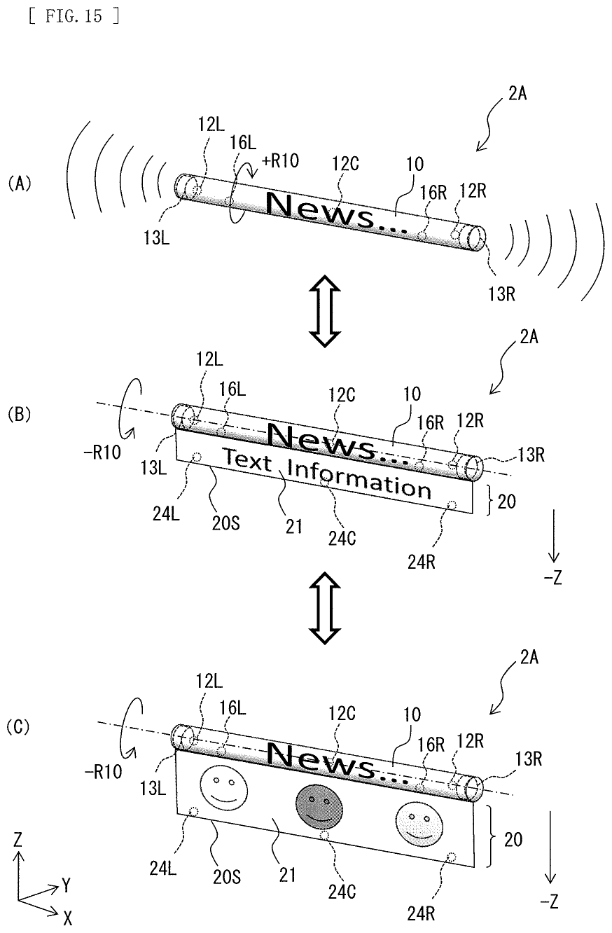

Next, referring to FIG. 15, description will be made on a display unit 2A as a first modification example of the second embodiment. FIG. 15 schematically illustrates an entire configuration example of the display unit 2A. In FIG. 15, in particular, (A) illustrates a first state (stored state) where the flexible display 20 is stored in the winder 10, corresponding to (A) of FIG. 13. (B) of FIG. 15 illustrates a second state where a portion of the flexible display 20 is slightly ejected from the winder 10, corresponding to (B) of FIG. 15. (C) of FIG. 15 illustrates a third state where a larger portion of the flexible display 20 is ejected from the winder 10, corresponding to (C) of FIG. 13.

In the display unit 2A, the display surface 21 of the flexible display 20 is wound on the winder 10 to face outside. The display unit 2A thus allows an image to be displayed on a portion wound by the winder 10 of the display surface 21. It is to be noted that FIG. 15 illustrates an example where text information is displayed on the portion wound by the winder 10 of the display surface 21.

### Second Modification Example of Second Embodiment

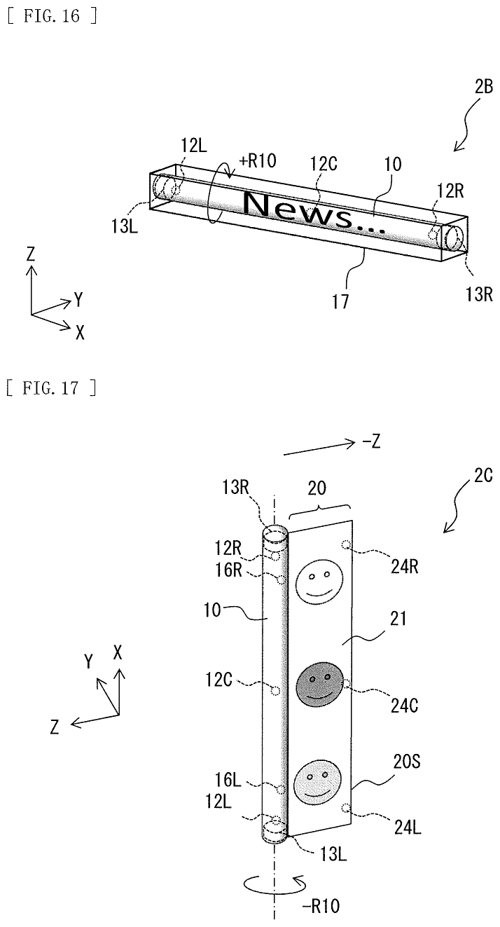

Next, referring to FIG. 16, description will be made on a display unit 2B as a second modification example of the second embodiment. FIG. 16 schematically illustrates an entire configuration example of the display unit 2B. In the display unit 2B, the winder 10 is housed in a transparent enclosure 17. Except for this, the display unit 2B has substantially the same configuration as that of the display unit 2A as the first modification example of the present embodiment illustrated in FIG. 15. In the display unit 2B, the winder 10 is housed in the transparent enclosure 17, which makes it possible to cause even text information displayed on the portion wound by the winder 10 of the display surface 21 to be visible from outside the enclosure 17, and makes it possible to protect the flexible display 20 in the stored state from dust, etc.

### Third Modification Example of Second Embodiment

Next, referring to FIG. 17, description will be made on a display unit 2C as a third modification example of the second embodiment. FIG. 17 schematically illustrates an entire configuration example of the display unit 2C. The display unit 2 is installed with the Z-axis direction corresponding to the vertical direction, but the display unit 2C is installed with the X-axis direction corresponding to the vertical direction. Except for this, the display unit 2C has substantially the same configuration as that of the display unit 2 according to the present embodiment illustrated in FIG. 13.

### Fourth Modification Example of Second Embodiment

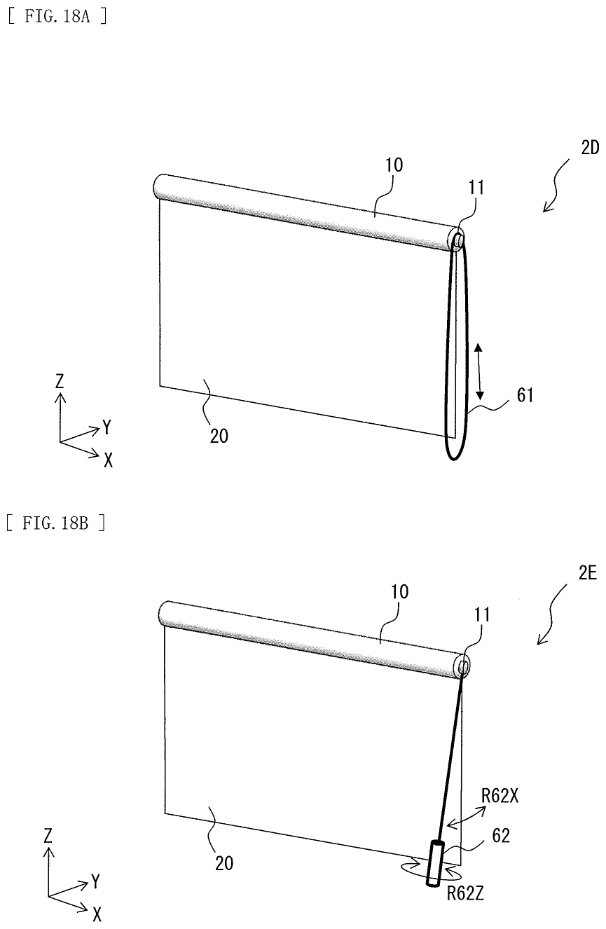

Next, referring to FIG. 18A, description will be made on a display unit 2D as a fourth modification example of the second embodiment. FIG. 18A schematically illustrates an entire configuration example of the display unit 2D. The display unit 2D includes a cord 61 as an operation section attached to the shaft 11 of the winder 10. Except for this, the display unit 2D has substantially the same configuration as that of the display unit 2 according to the present embodiment illustrated in FIG. 13. In the display unit 2D, use of the cord 61 makes it possible to perform not only a power on/off operation but also an ejection operation for ejecting the flexible display 20 from the winder 10 and a storing operation for storing the flexible display 20 in the winder 10. The cord 61 makes it possible to bidirectionally rotate the shaft 11. Further, a display operation for displaying an image on the display surface 21, such as channel switching or display mode switching, may be performed by pulling, for example, the shaft 11 in a specific direction via the cord 61. As described above, the display unit 2D allows a viewer to perform a basic operation intuitively and without feeling strangeness with use of the operation section similar to that of a typical roller blind or the like.

### Fifth Modification Example of Second Embodiment

Next, referring to FIG. 18B, description will be made on a display unit 2E as a fifth modification example of the second embodiment. FIG. 18B schematically illustrates an entire configuration example of the display unit 2E. The display unit 2E includes a shaft 62 as an operation section, attached to the shaft 11 of the winder 10. Except for this, the display unit 2E has substantially the same configuration as that of the display unit 2 according to the present embodiment illustrated in FIG. 13. In the display unit 2E, rotating the shaft 62 around the shaft 11, i.e., a rotation center axis, in an R62X direction makes it possible to perform the power on/off operation, and the ejection operation and storing operation of the flexible display 20, for example. Further, in the display unit 2E, rotating the shaft 62 in an R62Z direction makes it possible to perform the display operation for displaying an image on the display surface 21, such as channel switching or display mode switching. Alternatively, any other operation such as volume control may be performed. As described above, the display unit 2E also allows a viewer to perform the basic operation intuitively and without feeling strangeness with use of the operation section similar to that of a typical roller blind or the like.

### 3. Other Modification Examples

Although the description of the present disclosure has been given with reference to some embodiments and some modification examples, the present disclosure is not limited thereto and may be modified in a variety of ways. For example, the speakers 13L and 13R are provided inside the shaft 11 and the speakers 32L and 32R are provided inside the unwinder 30 in the above embodiments, etc.; however, the present disclosure is not limited thereto. According to the present disclosure, a vibration member with flexibility may be provided on a rear surface of the flexible display to regenerate sound information by causing vibration of the flexible vibration member, for example. Examples of such a flexible vibration member include a piezo film. In this case, a plurality of piezo films may be stacked.

In the above embodiments, etc., the detector is exemplified by the nine-axis sensors and the proximity sensors disposed in each of the winder and the unwinder and piezoelectric sensors disposed in the flexible display; however, the present disclosure is not limited thereto and other sensors or the like may be provided if necessary. In addition, installation positions of the respective sensors are not limited to those described in the above-described embodiments, etc. but may be changed if necessary. For example, a plurality of piezoelectric sensors may be further disposed, being arranged along the centerline CL.

It is to be noted that effects described herein are merely exemplified. Effects of the disclosure are not limited to the effects described herein. Effects of the disclosure may further include other effects. Moreover, the present technology may have the following configurations.

(1)

A display unit including:

a winder including a rotary shaft;

a flexible display that has a display surface where an image is displayed, and is windable and ejectable from the winder with rotation of the rotary shaft;

a detector that detects a state of the display surface of the flexible display ejected from the winder; and

a controller that performs switching control of a display mode of the image on the basis of the state of the display surface detected by the detector.

(2)

The display unit according to (1), in which

the detector detects an inclination, relative to a vertical direction, of the flexible display ejected from the winder, and

the controller performs, as the switching control of the display mode, inclination correction of the image in accordance with an inclination, relative to the vertical direction, of the display surface detected by the detector.

(3)

The display unit according to (1) or (2), in which

the detector detects an attitude, relative to the rotary shaft, of an edge of the flexible display ejected from the winder, the edge being opposite to the winder, and

the controller performs, as the switching control of the display mode, deformation correction of the image in accordance with the attitude, relative to the rotary shaft, of the edge of the flexible display detected by the detector.

(4)

The display unit according to any one of (1) to (3), in which

the detector detects a folding position in the flexible display ejected from the winder, and

the controller performs, as the switching control of the display mode, divisional display of the image in accordance with the folding position in the flexible display.

(5)

The display unit according to any one of (1) to (4), in which

the detector detects that the winder and an edge of the flexible display come into contact with or closer to each other, the edge being opposite to the winder, and the flexible display being ejected from the winder and cylindrically curved, and

the controller performs, as the switching control of the display mode, circumferential image display on the basis of the detection, by the detector, of the winder and the edge of the flexible display coming into contact with or closer to each other.

(6)

The display unit according to any one of (1) to (5), in which the detector includes a plurality of piezoelectric sensors.

(7)

The display unit according to any one of (1) to (6), in which the detector includes a nine-axis sensor including a gyroscope sensor, an acceleration sensor, and a geomagnetic sensor.

(8)

A display unit including:

a winder including a rotary shaft;

a flexible display that has a display surface where an image is displayed, and is windable and ejectable from the winder with rotation of the rotary shaft;

a detector that detects an amount of ejection, from the winder, of the flexible display to be ejected from the winder; and

a controller that performs switching control of a display mode of the image in accordance with the amount of ejection of the flexible display from the winder detected by the detector.

(9)

The display unit according to (8), further including a speaker that outputs a sound, in which

the controller further performs switching control of an acoustic mode of the sound in accordance with the amount of ejection of the flexible display from the winder detected by the detector.

(10)

The display unit according to (8) or (9), in which the controller selects, as the switching control of the display mode of the image, any one of an unlighted mode, a text display mode, a thumbnail display mode, or a full-screen display mode to display the image on the display surface.

(11)

The display unit according to any one of (8) to (10), in which the controller changes an amount of information regarding the image to be displayed on the display surface in accordance with the amount of ejection of the flexible display from the winder.

(12)

The display unit according to any one of (8) to (10), further including an operation section that is configured to perform both an ejection operation for ejecting the flexible display from the winder and a display operation for displaying the image on the display surface.

This application claims the benefit of Japanese Priority Patent Application JP2017-234629 filed on Dec. 6, 2017, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A display unit comprising:
a winder including a rotary shaft;
a flexible display that has a display surface where an image is displayed, and is windable and ejectable from the winder with rotation of the rotary shaft;
a detector that detects a state of the display surface of the flexible display ejected from the winder; and
a controller that performs switching control of a display mode of the image on a basis of the state of the display surface detected by the detector.

2. The display unit according to claim 1, wherein
the detector detects an inclination, relative to a vertical direction, of the flexible display ejected from the winder, and
the controller performs, as the switching control of the display mode, inclination correction of the image in accordance with an inclination, relative to the vertical direction, of the display surface detected by the detector.

3. The display unit according to claim 1, wherein
the detector detects an attitude, relative to the rotary shaft, of an edge of the flexible display ejected from the winder, the edge being opposite to the winder, and
the controller performs, as the switching control of the display mode, deformation correction of the image in accordance with the attitude, relative to the rotary shaft, of the edge of the flexible display detected by the detector.

4. The display unit according to claim 1, wherein
the detector detects a folding position in the flexible display ejected from the winder, and
the controller performs, as the switching control of the display mode, divisional display of the image in accordance with the folding position in the flexible display.

5. The display unit according to claim 1, wherein
the detector detects that the winder and an edge of the flexible display come into contact with or closer to each other, the edge being opposite to the winder, and the flexible display being ejected from the winder and cylindrically curved, and the controller performs, as the switching control of the display mode,
circumferential image display on a basis of the detection, by the detector, of the winder and the edge of the flexible display coming into contact with or closer to each other.

6. The display unit according to claim 1, wherein the detector includes a plurality of piezoelectric sensors.

7. The display unit according to claim 1, wherein the detector includes a nine-axis sensor including a gyroscope sensor, an acceleration sensor, and a geomagnetic sensor.

8. A display unit comprising:
a winder including a rotary shaft;
a flexible display that has a display surface where an image is displayed, and is windable and ejectable from the winder with rotation of the rotary shaft;
a detector that detects an amount of ejection, from the winder, of the flexible display to be ejected from the winder; and
a controller that performs switching control of a display mode of the image in accordance with the amount of ejection of the flexible display from the winder detected by the detector.

9. The display unit according to claim 8, further comprising a speaker that outputs a sound, wherein
the controller further performs switching control of an acoustic mode of the sound in accordance with the amount of ejection of the flexible display from the winder detected by the detector.

10. The display unit according to claim 8, wherein the controller selects, as the switching control of the display mode of the image, any one of an unlighted mode, a text display mode, a thumbnail display mode, or a full-screen display mode to display the image on the display surface.

11. The display unit according to claim 8, wherein the controller changes an amount of information regarding the image to be displayed on the display surface in accordance with the amount of ejection of the flexible display from the winder.

12. The display unit according to claim 8, further comprising an operation section that is configured to perform both an ejection operation for ejecting the flexible display from the winder and a display operation for displaying the image on the display surface.
